(19) United States
(12) Patent Application Publication
(10) Pub. No.: US 2015/0041335 A1
(43) Pub. Date: Feb. 12, 2015

(54) System and Method for Fuel Cell Based Compositional Sample Analysis

(71) Applicants: Matt A. Brown, Groton, MA (US); David Greaves, Peabody, MA (US)

(72) Inventors: Matt A. Brown, Groton, MA (US); David Greaves, Peabody, MA (US)

(73) Assignee: AA HOLDINGS, LTD., Wilmington, DE (US)

(21) Appl. No.: 14/455,304

(22) Filed: Aug. 8, 2014

Related U.S. Application Data
(60) Provisional application No. 61/863,477, filed on Aug. 8, 2013.

(51) Int. Cl. G01N 27/407; G01N 27/416

(52) U.S. Cl. CPC G01N 27/407; G01N 27/416
USPC 205/784; 204/406

(57) ABSTRACT

A system and method for compositional sample analysis includes a fluid sample handler having a sample pathway extending in a downstream direction from an input port to an output port, to transport a fluid sample therethrough. A sample conditioner is disposed within the sample pathway, to maintain the fluid sample within a predetermined temperature range. A fuel cell is disposed in serial fluid communication with said output port to receive the fluid sample, the fuel cell configured to use an oxidizer and the fluid sample to generate an electric potential corresponding to a concentration of a constituent of the fluid sample. A controller is communicably coupled to the fuel cell, and configured to capture and use the electric potential to calculate the concentration of the constituent.

### RELATED APPLICATION

This application claims the benefit of U.S. Provisional Patent Application Ser. No. 61/863,477, entitled Fuel Cell Analyzer, filed on Aug. 8, 2013, the contents of which are incorporated herein by reference in their entirety for all purposes.

### BACKGROUND

1. Technical Field

This invention relates to compositional sample analysis, and more particularly to a system and method for both batch and continuous online analysis of unknown concentrations of fuel gas using fuel cell-based sensors.

2. Background Information

Many chemicals are difficult to analyze using an online analyzer due to interferences and background noise in sensors when analyzing low relatively concentrations. One specific example is ethanol in water. Ethanol in water in ppm (parts-per-million) concentrations is very difficult to analyze using conventional approaches. PPM concentrations are typically not enough to create a distinctive peak in the IR (infrared) spectrum and conventional gas chromatography generally requires a lab unit and is not typically run in an online setting due to the relatively high maintenance required. While lab techniques are useful, they do provide real time analysis of the constituents currently running through the process stream.

Thus, a need exists for an improved analyzer that is suitable for online use, while also providing relatively high accuracy even at low concentrations of the sample constituent of interest.

### SUMMARY

In one aspect of the invention, an apparatus for compositional sample analysis includes a fluid sample handler having a sample pathway extending in a downstream direction from an input port to an output port, to transport a fluid sample therethrough. A sample conditioner is disposed within the sample pathway, to maintain the fluid sample within a predetermined temperature range. A fuel cell is disposed in serial fluid communication with said output port to receive the fluid sample, the fuel cell configured to use an oxidizer and the fluid sample to generate an electric potential corresponding to a concentration of a constituent of the fluid sample. A controller is communicably coupled to the fuel cell, and configured to capture and use the electric potential to calculate the concentration of the constituent.

In another aspect of the invention, a method for compositional sample analysis includes supplying a fluid sample to the input port of the apparatus of the preceding aspect of the above-described apparatus, and conveying the fluid sample in the downstream direction through the sample pathway. The sample conditioner is then actuated to maintain the fluid sample within the predetermined temperature range. The fluid sample is then received at the fuel cell, which is then actuated to use an oxidizer along with the fluid sample to generate an electric potential corresponding to a concentration of at least one constituent of the fluid sample. The controller is used to capture and use the electric potential to calculate the concentration of the constituent.

Yet another aspect of the invention includes a method of operating the above-described apparatus. The method includes supplying a fluid sample of a known concentration of a known constituent to the sample handler, capturing the electric potential generated by the fuel cell in response to the supplying, and storing, with the controller, the identity of the known constituent, the concentration of the known constituent, and the captured electric potential. These steps are then repeated for a plurality of different concentrations of the known constituent. A fuel sample of an unknown concentration of the known constituent is then supplied to the sample handler, with the electric potential generated by the fuel cell being captured and compared to stored values to determine the unknown concentration.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a schematic diagram of a portion of one embodiment of a sample analysis apparatus of the present invention;

FIG. 2 is a schematic diagram of another portion of the embodiment of FIG. 1;

FIG. 3 is a block diagram of one embodiment of a system controller usable in embodiments of the present invention;

FIG. 4 is a graphical representation of test results achieved by an embodiment of the present invention; and

FIG. 5 is a graphical representation of test results achieved by another embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

As used in the specification and in the appended claims, the singular forms “a”, “an”, and “the” include plural referents unless the context clearly indicates otherwise. For example, reference to “an analyzer” includes a plurality of such analyzers. In another example, reference to “an analysis” includes a plurality of such analyses.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

In the following description, for purposes of explanation, numerous specific details are set forth in order to provide a thorough understanding of the present invention. It will be evident, however, to one skilled in the art that the present invention may be practiced without these specific details.

As used herein, the terms “computer” and “controller” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Moreover, the various components may be localized on one computer and/or distributed between two or more computers. The term “real-time” refers to sensing and responding to external events nearly simultaneously (e.g., within milliseconds or microseconds) with their occurrence, or without intentional delay, given the processing limitations of the system and the time required to accurately respond to the inputs.

Systems and methods embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

Conventional fuel cells are used to convert the potential energy stored in the bonds of materials such as hydrogen, natural gas, methanol, and ethanol into useable energy for a variety of applications. Fuel cells thus use these materials as fuel sources, along with oxygen, catalyst, and a membrane to produce an electric potential, which can be measured as a voltage. This electric potential is commonly used to produce power for industry, cars, and some home units. Moreover, these fuel cells use highly pure gas to obtain the highest power output and maximum efficiency.

The present inventors have taken the novel approach of using a fuel cell in an industrial scale analytical application. Instead of providing a constant high purity fuel gas to the fuel cell, a fuel cell is incorporated into an analysis system configured to supply a process stream containing an unknown concentration of a fuel gas to the fuel cell. This produces a voltage across the membrane of the fuel cell that is proportional or otherwise correlated to the concentration of the fuel gas (constituent) of interest within the process stream.

In one specific example a fluid sample from a process stream is brought into the gas (vapor) phase. The fluid sample then continues through the fuel cell. The amount of the constituent of interest (e.g., the concentration of the particular fuel gas) within the sample that passes through the fuel cell creates a specific amount of electric potential, which can be measured e.g., as a voltage. Using this voltage, the amount of the material of interest within the sample can be determined by correlating the voltage to voltages and/or voltage curves generated by passing known samples through the system. In this regard, those skilled in the art will recognize that by initially providing the system with fuel samples of various known concentrations a calibration curve can be calculated. This curve can then be used to correlate the voltage to the concentration of an unknown fuel gas/constituent.

The present inventors have found that fuel cells provide the analysis system of the present invention with relatively fast detection time and high accuracy even at relatively low concentrations. These aspects permit the units to be used in an online setting. The use of fuel cells also provides these analysis systems with relatively high selectivity, due to the selectivity of fuel cell membranes. This may lead to relatively low levels of interference between various constituents within the process stream, and a relatively stable output.

In an alternate embodiment, components of the aforementioned system are used with an otherwise conventional gas chromatograph. In this embodiment, a specific volume of sample is taken into the vapor phase and brought through the gas chromatograph. This separates out the constituent of interest which is then passed through the fuel cell, pushed by a carrier gas. The magnitude of the voltage created by the gas passing through the fuel cell again correlates to the amount of the constituent of interest within the sample.

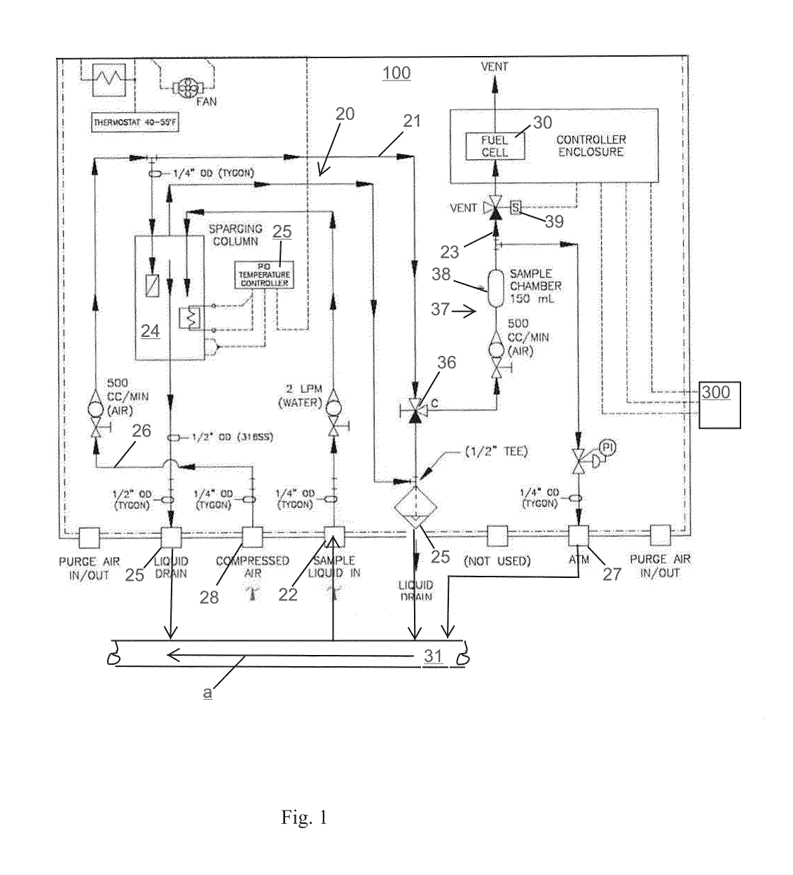

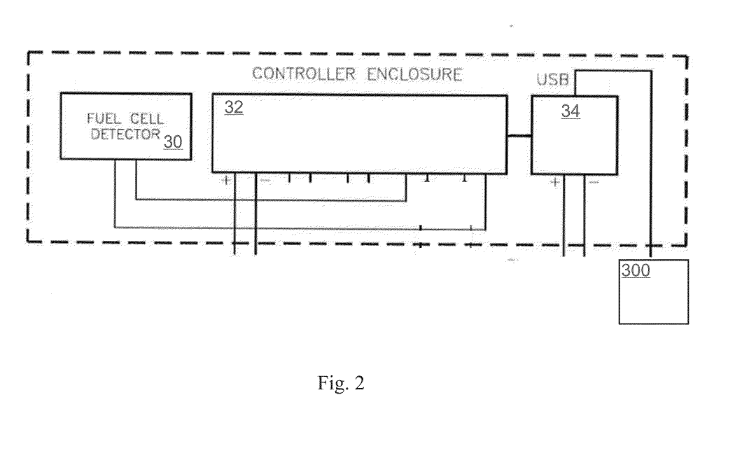

Referring now to FIGS. 1 and 2, particular embodiments of the present invention will be more thoroughly described. As shown in FIG. 1, a representative sample analysis system 100 of the present invention includes a fluid sample handler 20 having a sample pathway extending in a downstream direction from an input port 22 to an output port 23. A sample conditioner 24 is disposed within the sample pathway, and is configured to maintain the fluid sample within a predetermined temperature range, e.g., using a temperature controller 25. In various embodiments, sample conditioner 24 is configured to maintain the fluid sample within a temperature range of about 0-200 degrees C. at atmospheric pressure to about 20 psig (140 kpa). Particular embodiments are configured to maintain the sample at room temperature, e.g., within a range of about 18-25 degrees C. at atmospheric pressure to about 10 psig (70 kpa). It should be recognized that substantially any suitable temperatures and pressures may be used, depending on the particular application.

In addition, in various embodiments, the sample conditioner 24 is configured to convert the fluid sample from liquid phase to gas phase. For example, sample conditioner may take the form of a conventional sparging column, configured to bubble a gas such as air through the liquid sample to remove gas from the sample. Any number of other devices commonly used for liquid/gas separation may be used, including, for example, a gas chromatography column which those skilled in the art will recognize is commonly used to separate out the various constituents of a fluid sample.

As also shown, a fuel cell detector 30 is disposed in serial fluid communication with output port 23, to receive the fluid sample passing therethrough. From the standpoint of the underlying chemistry, fuel cell 30 operates in a substantially conventional manner, by using a fuel gas and an oxidizer such as oxygen, along with a membrane selective to the particular fuel gas, to generate an electric potential. However, as shown and described herein, rather than being fed a pure fuel gas, fuel cell 30 is supplied with a sample, via port 23, which has an unknown concentration of a fuel gas constituent. In these embodiments, the fuel cell 30 generates an electric potential that corresponds to the concentration of at least one constituent of the fluid sample. Examples of fuel cells that may be used in embodiments of the present invention include the FC1 fuel cell commercially available from Fuel Cell Sensors, Hanover House, Hanover Street, Barry Vale of Glamorgan, Wales.

A system controller 300 (FIG. 2) communicably coupled to the fuel cell 30, is configured to capture the electric potential, and to use the captured electric potential to calculate the concentration of the fuel gas constituent. In particular embodiments, a voltage detector 32 is communicably coupled to the fuel cell and to the controller, to measure the voltage of the electric potential, which is then captured by the controller 300. In various embodiments, a database of voltages corresponding to known concentrations of the constituent is generated or acquired, as discussed hereinbelow. The controller 300 may then be used to compare the measured voltage to the database, to calculate the concentration of the constituent. The database may take the form of a lookup table, graph, etc., as discussed in greater detail hereinbelow.

It is noted that in particular embodiments, system 100 is configured to supply the fluid sample in the gas phase to the fuel cell 30. This may be facilitated by use of a carrier gas, such as compressed air, which is supplied through a carrier gas input port 28, and used to carry the fluid sample through a portion of the sample pathway. System 100 may be provided with various valves, such as 3-way valves operated by controller 300, which may be actuated to supply the carrier gas to the sample path upstream of the sample, e.g., at a point upstream of fuel cell input line 37. It should be recognized that the carrier gas may be supplied in a similar manner to purge the sample from the sample pathway.

In the particular embodiment shown in FIG. 1, system 100 is configured for online operation, by connecting the system to a fluid process 31 at input port 22, and at drains 25 and 27. In this embodiment, the fluid process flows in the direction indicated by arrow a, with process fluid being withdrawn from the process and supplied to system 100 at sample port 22. After testing, the sample fluid may be returned to the process 31 via drains 25, 27.

During operation of one embodiment of system 100, a liquid sample is supplied to the sample loop 20, e.g., from fluid process 31, via input port 22, where it flows in the downstream direction through the sample pathway to sample conditioner 24. The sample conditioner maintains the fluid sample within the predetermined temperature range. The sample then continues through the sample pathway to outlet 23, from which it is received at the fuel cell 30. The fuel cell uses an oxidizer along with the fluid sample to generate an electric potential corresponding to a concentration of at least one constituent of the fluid sample. Controller 300 (FIG. 2) captures the electric potential and uses it to calculate the concentration of at least one constituent of the sample.

Various optional operational aspects incorporated into system 100 will now be described. For example, a carrier gas, such as compressed air, may be supplied to feed line 26 via input port 28, where it also flows to a sample conditioner 24 in the form of a sparging column or gas chromatograph, etc., as described hereinabove. At column 24, the carrier gas is sparged through the liquid sample, to take the sample out of the liquid phase and into the gas phase. In the embodiment shown, the sparging column 24 includes an optional temperature controller 25 configured to maintain the temperature within the column 24 within the predetermined temperature range discussed hereinabove. Those skilled in the art will recognize that this temperature range may vary depending on the constituents of the particular sample liquid, the carrier gas used, and the pressure within sample loop 20. The sample exits column 24, and any excess liquid is drained, and optionally returned to process 31, at liquid drain 34. The gas phase sample then flows, e.g., through a 3-way valve 36, to fuel call 30, via fuel cell input line 37. Those skilled in the art will recognize that particular embodiments use the optional 3-way valve 36 to alternately supply the carrier gas (via feed line 26 through line 21 as shown) to input line 37 to purge out the sample, or to allow sample to flow into the fuel cell 30. As also shown, in particular embodiments, the sample flows to fuel cell 30 via a sample chamber 38, which is optionally used to help ensure that an adequate amount of sample is present already in the gas phase for analysis, while a solenoid valve 39 actuated by system controller 300, is used to permit a specific, controlled amount of sample gas to flow into the fuel cell 30 for analysis. In particular embodiments, when the sample is not passing into the fuel cell, the sample may be permitted to flow out of the system 100 through sample exit 27, and optionally returned to process 31 as shown, to relieve pressure within the sample loop 20 and to ensure that new, fresh sample is present when the fuel cell solenoid valve 39 opens again. It should be recognized that the carrier gas may be supplied in a similar manner to purge the sample from the input line 37 through line 21 if three way valve 36 is flipped.

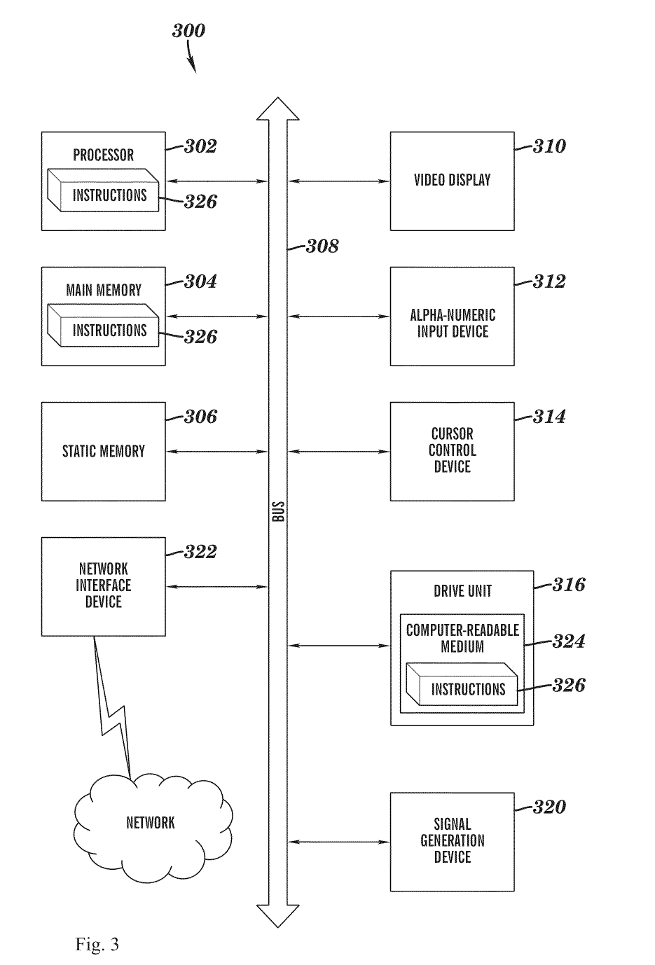

As shown in FIG. 2, the electric potential generated by fuel cell 30 in response to the sample passing through it, is applied to a voltage detector 32. Any conventional voltage detector may be used. The voltage may then be communicated via port 34 to the system controller 300 (FIG. 3) where it is correlated to a calibration curve, lookup table, or other data generated by passing known sample gases, at known concentrations, through the fuel cell 30 as discussed hereinabove, to determine the concentration of the constituent of interest.

In this regard, those skilled in the art will recognize that by initially providing the system with fuel samples of various known concentrations a data set in the form of a calibration curve can be calculated. This curve can then be used to correlate the voltage to the concentration of an unknown fuel gas. For example, referring to Table I, a method of calibrating the sample apparatus of the present invention, is described.

At 40, a fluid sample having a known concentration of a known constituent is supplied to the sample handler. At 42, the electric potential generated by the fuel cell is captured. At 44, the controller stores the identity of the known constituent, the concentration of the known constituent, and the captured electric potential. Steps 40 to 44 are repeated at 46, for various different concentrations of the known constituent. At 48, a fuel sample having an unknown concentration of the known constituent is supplied to the sample handler. The electric potential generated by the fuel cell in response to step 48 is captured at 50 and compared, at 52, to values stored at steps 44 and 46.

Various optional steps are shown at steps 54 to 64, which include repeating step 46 for a plurality of different concentrations of other known constituents at 54. At 56, steps 44-46 also includes storage into a lookup table, and at 58, the lookup table is used to identify the concentration of the constituent. At 60, steps 44-46 include plotting the concentration of the known constituent versus the captured electric potential on a graph. At 62, step 60 also includes fitting a curve to points on the graph and generating a mathematical equation defining the curve. At 64, the electric potential is inserted into the equation, which is then solved to determine the unknown concentration.

TABLE I

| | |
|---|---|
| 40 | Supply known sample to sample handler; |
| 42 | Capture electric potential; |
| 44 | Store identity, concentration, and captured |
| | electric potential of the known constituent; |
| 46 | Repeat 40-44 for a plurality of different concentrations; |
| 48 | Supply sample having unknown concentration |
| | of the known constituent to the sample handler; |
| 50 | Capture electric potential |
| | generated in response to 48; and |
| 52 | Compare the electric potential captured |
| | at 50 to values stored at 44 and |
| | 46 to determine the unknown concentration. |
| 54 | Optionally, repeat step 46 for a plurality |
| | of different concentrations of |
| | other known constituents. |
| 56 | Optionally, store results of steps |
| | 44-46 in a lookup table. |
| 58 | Optionally, use the lookup table to |
| | identify a corresponding concentration. |
| 60 | Optionally, plot the results of steps 44-46 in a graph. |
| 62 | Optionally, fit a curve to points on |
| | the graph and generate a mathematical |
| | equation defining the curve. |
| 64 | Optionally, insert the electric potential |
| | into the equation, and solve the equation |
| | to determine the unknown concentration. |

FIG. 3 shows a diagrammatic representation of a system controller 300 in the exemplary form of a computer system within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The controller 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention, and as further described hereinbelow.

Furthermore, embodiments of the present invention include a computer program code-based product, which includes a computer readable storage medium having program code stored therein which can be used to instruct a computer to perform any of the functions, methods and/or modules associated with the present invention. The non-transitory computer readable medium includes any of, but not limited to, the following: CD-ROM, DVD, magnetic tape, optical disc, hard drive, floppy disk, ferroelectric memory, flash memory, phase-change memory, ferromagnetic memory, optical storage, charge coupled devices, magnetic or optical cards, smart cards, EEPROM, EPROM, RAM, ROM, DRAM, SRAM, SDRAM, and/or any other appropriate static, dynamic, or volatile memory or data storage devices, but does not include a transitory signal per se.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

The following illustrative example demonstrates certain aspects and embodiments of the present invention, and are not intended to limit the present invention to any one particular embodiment or set of features.

### EXAMPLES

### Example 1

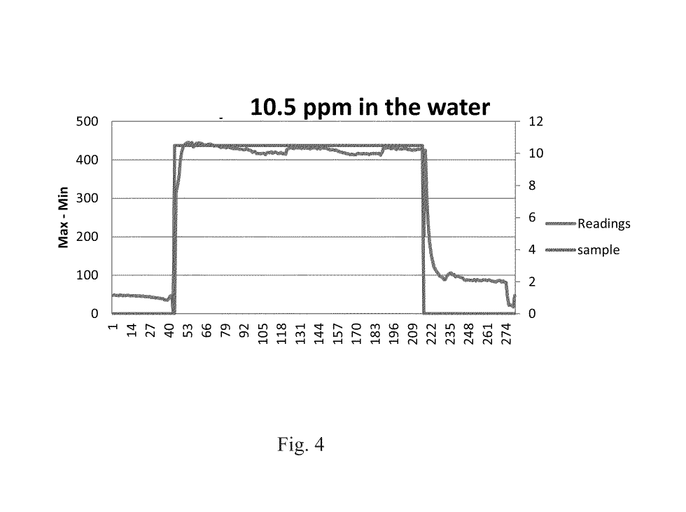

A sampling system such as shown and described with respect to FIGS. 1-3 was built with a sparging column 24, and an FC1 fuel cell from Fuel Cell Sensors, of Hanover House, Hanover Street, Barry Vale of Glamorgan, Wales, operated at room temperature, and configured for batch processing. A sample was created of 10.5 ppm ethanol in water and supplied to column 24. The response is shown in FIG. 4, and indicates that the response time for the analyzer was very quick, achieving approximately 70 percent of maximum (7.4 ppm) after 1 minute, and achieving 90 percent of maximum (9.5 ppm) after 4 minutes.

### Example 2

The system of Example 1 was modified for continuous (e.g., online) operation. Sparging column 24 was equipped with a float drain, which allowed liquid sample to fill a volume to be sparged. The volume was continuously filled with sample fluid from the bottom with overflow fed from the top into a liquid only drain 25. There was also a continuous flow of compressed air at 10 psig (70 kpa) pressure at 26 into the volume to pressurize the sample vapor at 10 psig (70 kpa) pressure that was fed to the fuel cell. The sample fluid was thus continuously fed through the sparging column to permit continuous measurement.

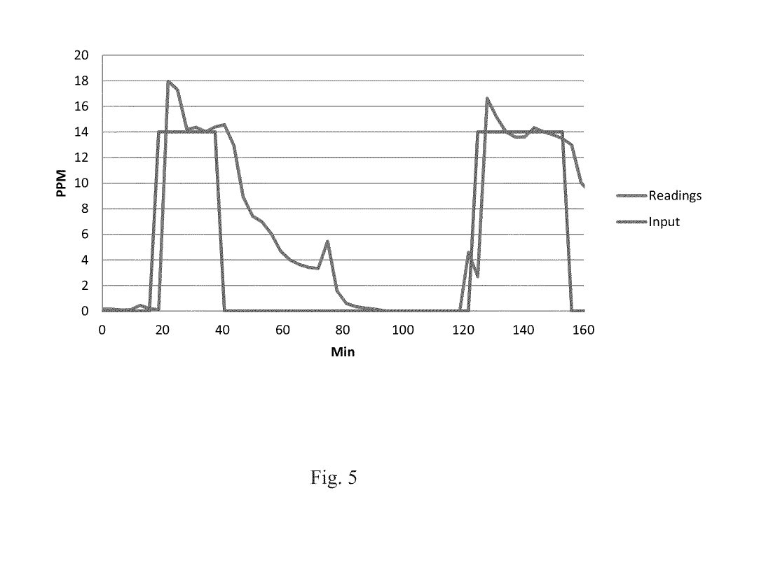

A 14 ppm ethanol in water sample was created and was run through the system at 0.25 liters/min and the carrier gas (compressed air) was run through the system at 200 ml/min. The samples were alternated between water and the 14 ppm sample, using a 3-way valve. The sample was run until a stable reading was achieved and then it was switched to water and then back to sample. These test results are shown in FIG. 5, with the red line indicating the actual timing of when the 3-way valve was used to switch between the sample and water. The blue line indicates the detector's response.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

It should be further understood that any of the features described with respect to one of the embodiments described herein may be similarly applied to any of the other embodiments described herein without departing from the scope of the present invention.

Having thus described the invention, what is claimed is:

1. An apparatus for compositional sample analysis, the apparatus comprising:
a fluid sample handler having a sample pathway extending in a downstream direction from an input port to an output port, the sample pathway configured to transport a fluid sample in the downstream direction therethrough;
a sample conditioner disposed within the sample pathway, the sample conditioner configured to maintain the fluid sample within a predetermined temperature range;
a fuel cell disposed in serial fluid communication with said output port, to receive the fluid sample passing therethrough;
the fuel cell configured to use an oxidizer and the fluid sample to generate an electric potential corresponding to a concentration of at least one constituent of the fluid sample; and
a controller communicably coupled to the fuel cell, the controller configured to capture the electric potential, and to use the captured electric potential to calculate the concentration of the at least one constituent.

2. The apparatus of claim 1, further comprising a voltage detector communicably coupled to the fuel cell and to the controller, the voltage detector configured to measure the voltage of the electric potential, wherein the measured voltage is captured by the controller.

3. The apparatus of claim 2, further comprising a database of voltages corresponding to known concentrations of the at least one constituent.

4. The apparatus of claim 3, wherein the controller is configured to compare the voltage of the captured electric potential to the database, to calculate the concentration of the at least one constituent.

5. The apparatus of claim 1, wherein the sample conditioner is configured to convert the fluid sample from liquid phase to gas phase.

6. The apparatus of claim 5, wherein the sample conditioner comprises a sparging column.

7. The apparatus of claim 5, wherein the sample conditioner comprises a gas chromatograph.

8. The apparatus of claim 1, wherein the fuel cell comprises a membrane configured to be selective to the at least one constituent of the fluid sample.

9. The apparatus of claim 1, wherein the fuel cell uses air or oxygen as an oxidizer.

10. The apparatus of claim 5, wherein the fluid sample handler is configured to supply a fluid sample in the gas phase to the fuel cell.

11. The apparatus of claim 10, further comprising a carrier gas input port configured to receive a carrier gas therein, wherein the system is configured to use the carrier gas to bring the sample into the vapor phase and carry it through the sample pathway.

12. The apparatus of claim 11, wherein the system is configured to purge the sample from the sample pathway.

13. A method for compositional sample analysis, the method comprising:
(a) supplying a fluid sample to the input port of the apparatus of claim 1, and conveying the fluid sample in the downstream direction through the sample pathway;
(b) actuating the sample conditioner to maintain the fluid sample within the predetermined temperature range;
(c) receiving the fluid sample at the fuel cell;
(d) actuating the fuel cell to use an oxidizer along with the fluid sample to generate an electric potential corresponding to a concentration of at least one constituent of the fluid sample; and
(e) with the controller, capturing the electric potential and using the captured electric potential to calculate the concentration of the at least one constituent.

14. The method of claim 13, further comprising measuring the voltage of the electric potential with a voltage detector communicably coupled to the fuel cell and to the controller, and capturing the measured voltage with the controller.

15. The method of claim 14, further comprising comparing, with the controller, the measured voltage to a database of voltages corresponding to known concentrations of the at least one constituent.

16. The method of claim 13, further comprising using the sample conditioner to convert the fluid sample from liquid phase to gas phase.

17. The method of claim 16, comprising using a sparging column to convert the fluid sample from liquid phase to gas phase.

18. The method of claim 17, comprising using a gas chromatograph to convert the fluid sample from liquid phase to gas phase.

19. The method of claim 16, comprising using a carrier gas to carry the sample through the sample pathway.

20. The method of claim 19, comprising purging the sample from the sample pathway.

21. A method of operating the apparatus of claim 1, the method comprising:
(a) supplying a fluid sample of a known concentration of a known constituent to the sample handler;
(b) capturing the electric potential generated by the fuel cell in response to said supplying (a);
(c) storing, with the controller, the identity of the known constituent, the concentration of the known constituent, and the captured electric potential;
(d) repeating steps (a)-(c) for a plurality of different concentrations of the known constituent;
(e) supplying a fuel sample of an unknown concentration of the known constituent to the sample handler;
(f) capturing the electric potential generated by the fuel cell in response to said supplying (e); and
(g) comparing the electric potential captured at (f) to values stored at (c) to determine the unknown concentration.

22. The method of claim 21, wherein said repeating (d) further comprises repeating said steps (a)-(c) for a plurality of different concentrations of other known constituents.

23. The method of claim 21, wherein said storing (c) further comprises storing the identity of the known constituent, the concentration of the known constituent, and the captured electric potential, in a lookup table.

24. The method of claim 23, wherein said comparing (g) further comprises looking up the electric potential captured at (f) in the lookup table to identify a corresponding concentration.

25. The method of claim 21, wherein said storing (c) further comprises plotting the concentration of the known constituent versus the captured electric potential on a graph.

26. The method of claim 25, further comprising fitting a curve to points on the graph and generating a mathematical equation defining the curve.

27. The method of claim 26, wherein said comparing (g) comprises inserting the electric potential captured at (f) into the equation, and solving the equation to determine the unknown concentration.
